(19) United States
(12) Patent Application Publication
(10) Pub. No.: US 2019/0236508 A1
(43) Pub. Date: Aug. 1, 2019

(54) KPI SPOTLIGHT FOR MANUFACTURING PROCESS

(71) Applicant: General Electric Company, Schenectady, NY (US)

(72) Inventors: Peter SAGE, Stephentown, NY (US); Vikas RATHEE, San Ramon, CA (US)

(21) Appl. No.: 15/882,025

(22) Filed: Jan. 29, 2018

(51) Int. Cl. G06Q 10/06

(52) U.S. Cl. CPC G06Q 10/06393

(57) ABSTRACT

The example embodiments are directed to a system and method for detecting operating patterns within a manufacturing process. In one example, the method may include receiving machine data from the manufacturing process and contextual information associated with the manufacturing process including a plurality of dynamic contextual attributes that change over time, determining KPIs for different permutations of the manufacturing process, where each KPI permutation is associated with a plurality of values for the plurality of dynamic contextual attributes, respectively, automatically detecting an operating pattern within the manufacturing process based on the determined KPIs and automatically detecting one or more values of the plurality of dynamic contextual attributes linked to the detected operating pattern, and outputting information about the detected operating pattern and the values of the plurality of dynamic contextual attributes linked to the detected operating pattern for display.

### BACKGROUND

Machine and equipment assets are engineered to perform particular tasks as part of a process. For example, assets can include, among other things and without limitation, industrial manufacturing equipment on a production line, drilling equipment for use in mining operations, wind turbines that generate electricity on a wind farm, transportation vehicles, gas and oil refining equipment, and the like. As another example, assets may include devices that aid in diagnosing patients such as imaging devices (e.g., X-ray or MM systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software. For example, analytic applications are being used to visualize and enhance operations of machine and equipment assets using data captured from an asset. Analytics can provide some form of understanding of the data to a user.

Key performance indicators (KPIs) are a type of analytic that can indicate how effectively a machine or an equipment is performing. The KPI itself is a metric upon which a decision or an action may be taken to change an outcome at the plant. Related KPI analysis is performed by a person (operator) who chooses a KPI and a machine or process to analyze with the KPI, and then reads the result of the KPI measurement. The user often must select from any number of known KPIs which can include standard KPIs and even customized KPIs. However, there can be dozens or even hundreds of different KPIs that are available some of which may be unknown to the user. Furthermore, each measurement requires various dimensions to be chosen by the user such as a time frame, a product, an operator, etc. When spread out across all possible machines, operators, time frames, products, etc. there can be thousands of KPI measurements that can possibly be performed.

For a user to manually go through the process of selecting and analyzing thousands of KPI measurements is impractical, if not impossible. Instead, the person typically decides on a few KPIs to perform across a few dimensions based on their subjective judgment. However, such analysis provides only a limited amount of insight into the manufacturing process and does not provide the user with a full comprehension of the operating characteristics of the manufacturing process. As a result, the user is prevented from realizing and understanding issues within the manufacturing process thereby leaving the manufacturing process operating below capacity.

### SUMMARY

The example embodiments improve upon the prior art by providing a KPI spotlighting system that can process KPIs across any amount of desired dimensions and time frames, and automatically detect patterns of performance and operating behavior within the manufacturing process based on the processed KPIs. In addition, the system can provide context associated with the detected pattern such as a product, a user, a plant, a machine, a time of day, and the like, which is a possible cause of the pattern. The system is able to look at KPI information and determine automatically what is interesting rather than a human analyzing a KPI. The pattern may encapsulate a period of time where a portion of the manufacturing process is excelling or is performing below expectations. The example embodiments take the human element out of the KPI analysis thereby removing the subjective determination or favoritism associated with using KPIs. Furthermore, the system can automatically detect patterns based on KPI information from across a wider spectrum of KPI analysis in an automated manner thereby generating a fuller understanding of the manufacturing process.

According to an aspect of an example embodiment, a computing system includes one or more of a network interface configured to receive machine data from a manufacturing process and contextual information associated with the manufacturing process, the contextual information including a plurality of dynamic contextual attributes that change over time, a processor configured to determine key performance indicators (KPIs) for different permutations of the manufacturing process, where each KPI permutation is associated with a plurality of values for the plurality of dynamic contextual attributes, respectively, and automatically detect an operating pattern within the manufacturing process based on the determined KPIs and automatically detect one or more values of the plurality of dynamic contextual attributes linked to the detected operating pattern, and an output configured to output information about the detected operating pattern and the one or more values of the plurality of dynamic contextual attributes linked to the detected operating pattern for display on a display device.

According to an aspect of another example embodiment, a computer-implemented method includes one or more of receiving machine data from a manufacturing process and contextual information associated with the manufacturing process, the contextual information including a plurality of dynamic contextual attributes that change over time, determining key performance indicators (KPIs) for different permutations of the manufacturing process, where each KPI permutation is associated with a plurality of values for the plurality of dynamic contextual attributes, respectively, automatically detecting an operating pattern within the manufacturing process based on the determined KPIs and automatically detecting one or more values of the plurality of dynamic contextual attributes linked to the detected operating pattern, and outputting information about the detected operating pattern and the one or more values of the plurality of dynamic contextual attributes linked to the detected operating pattern for display on a display device.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing environment in accordance with an example embodiment.

FIG. 2 is a diagram illustrating a process for determining a KPI in accordance with an example embodiment.

FIG. 3 is a diagram illustrating a host platform for detecting patterns from KPI of a manufacturing process in accordance with an example embodiment.

FIG. 4 is a diagram illustrating a user interface displaying operating patterns of a manufacturing process in accordance with an example embodiment.

FIG. 5 is a diagram illustrating a method for detecting patterns from a manufacturing process in accordance with another example embodiment.

FIG. 6 is a diagram illustrating a computing system in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a system that can receive machine and/or process data associated with a manufacturing process, and automatically detect operating patterns from within the data and context at the manufacturing plant that is linked to the operating patterns. According to various aspects, the system can process KPIs across any amount of desired dimensions and time frames of the manufacturing process, and automatically detect the patterns based on an analysis of the KPIs. As an example, the system can detect a period of time where a particular machine or equipment is operating below a predetermined threshold based on historical data of the machine or equipment Furthermore, the system can also detect a dynamic attribute of the manufacturing process that is linked to (e.g., a possible cause of) the reduced operating efficiency such as an operator, a type of product being manufactured, a day of the week, an hour of the day, a shift/crew, a combination thereof, and the like.

That is, the system can automatically detect operating patterns of interest and also automatically detect a dynamic attribute or attributes that are linked to the detected operating patterns of interest. The system is able to look at KPI information and automatically detect what is interesting rather than a human analyzing a KPI. For example, the system can identify operating patterns within the plant/process based on historical information of the manufacturing process or similar manufacturing processes to thereby determine whether a poor KPI performance metric is an isolated event or whether it is part of a larger pattern of behavior. The historical information may be learned from machine learning algorithms which create models of behavior for machines and processes of the plant. The patterns may be repetitive and may occur at certain periods of time and not at other periods of time. The patterns may be indicative of a specific product, a specific shift, a specific operator, a time of day, etc., which the system can automatically identify from analyzing KPI data across many different permutations as well as contextual information associated with the KPI permutations.

The area of concern or area of interest associated with the pattern may be a period where a portion of the manufacturing process is excelling or periods where it is not performing as expected. The example embodiments take the human element out of the KPI analysis thereby removing the subjective determination or favoritism associated with deciding which KPIs to use because and also determining which performance metric is simply an anomaly or which performance metric is part of a larger pattern of behavior at the manufacturing plant. Furthermore, the system can also identify patterns from across a wider spectrum of KPI analysis in an automated manner based on historical models thereby generating a fuller understanding of the manufacturing process. Furthermore, in some embodiments, the system can predict what is going to happen at the manufacturing plant based on the KPI data.

The system and the software described herein may be incorporated within or otherwise used in conjunction with applications for managing machine and equipment assets and can be hosted within an Industrial Internet of Things (IIoT). For example, an IIoT may connect manufacturing plants and assets, such as turbines, jet engines, locomotives, elevators, healthcare devices, mining equipment, oil and gas refineries, and the like, to the Internet, the cloud, and/or to each other in some meaningful way such as through one or more networks. The system described herein can be implemented within a “cloud” or remote or distributed computing resource which includes clustered computing resources capable of efficiently processing thousands or even millions of KPIs across different permutations. The cloud can be used to receive, relay, transmit, store, analyze, or otherwise process information for or about assets and manufacturing sites. The cloud computing system can further include or can be coupled with one or more other processor circuits or modules configured to perform a specific task, such as to perform tasks related to asset maintenance, analytics, data storage, security, or some other function.

Integration of machine and equipment assets with the remote computing resources to enable the IIoT often presents technical challenges that are separate and distinct from the specific industry and from computer networks, generally. An asset (e.g., machine or equipment) may need to be configured with novel interfaces and communication protocols to send and receive data to and from distributed computing resources. Also, assets may have strict requirements for cost, weight, security, performance, signal interference, and the like. As a result, enabling such an integration is rarely as simple as combining the asset with a general-purpose computing system.

The Predix™ platform available from GE is a novel embodiment of such an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial and/or healthcare based assets can be uniquely situated to leverage its understanding of assets themselves, models of such assets, and industrial operations or applications of such assets, to create new value for industrial customers through asset insights.

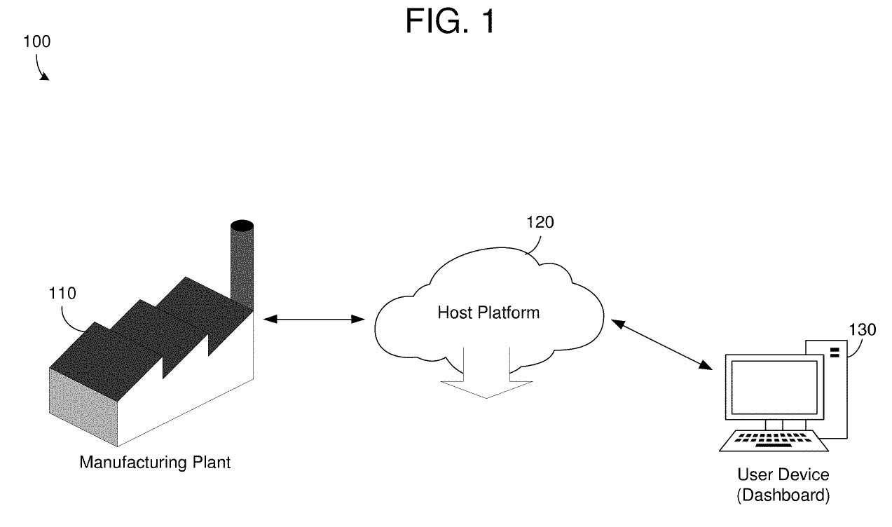

FIG. 1 illustrates a cloud computing environment 100 for detecting patterns within a manufacturing process in accordance with an example embodiment. Referring to FIG. 1, the cloud computing environment 100 includes a manufacturing site 110 which may include machines, equipment, processes (e.g., software), firmware, people, and the like, which can generate data about a manufacturing process and transmit the data to a database which may be included within a cloud platform or a remote database. In this example, a cloud platform 120 receives the data from the manufacturing site 110, however, embodiments are not limited thereto. As another example, the host platform may be a server that is on-premises at the manufacturing site 110, an industrial PC, an industrial edge server, an asset controller, and the like. The data may include raw time series data that is captured by machine logs performing manufacturing operations. As another example, the data may include contextual information such as schedules, notes, repair orders, material/parts orders, and the like.

According to various aspects, the host platform 120 may perform KPI spotlight analysis on the manufacturing process data received from one or more machines, equipment, process, etc. of a manufacturing process performed at manufacturing site 110, and detect operating patterns within the manufacturing process. Furthermore, the host platform 120 may link the detected operating patterns to one or more dynamic variables (referred to herein as attributes) within the manufacturing process such as users, products, crews, time of day, and the like. The host platform 120 may output information about the detected operating patterns and the context to a user device 130 via a user interface such as a dashboard or the like. The dashboard may display charts, graphs, tables, dials, and the like, that visually provide information to a viewer. The user device 130 may include a computing system such as an asset controller, a work station, an industrial PC, a user terminal such as a desktop, laptop, mobile phone, etc., and the like.

The host platform 120 may be included within an IIoT that connects a cluster of computers and assets/sites and which may be a distributed across multiple cloud computing platforms including databases, stream processors, servers, and the like. The data stored at the host platform 120 or passing through the host platform 120 may be processed using one or more applications published or otherwise provide by developers. The machine data that is provided to the host platform 120 may include time series data sensed or otherwise captured by sensors or other mechanisms coupled to or associated with machines or equipment used in industry, manufacturing, healthcare, transportation, energy, or the like. Also, although not shown in FIG. 1, the manufacturing site 110 may include or otherwise be connected to computing systems such as industrial computers, asset control systems, intervening industrial servers, and the like, which are coupled to or in communication with machines and equipment at the site 110.

In the example of FIG. 1, an asset management platform (AMP) can reside in or otherwise be connected to the host platform 120 and may be included in a local or sandboxed environment, or can be distributed across multiple locations or devices and can be used to interact with the assets 110 which may publish sensor data and other raw and filtered data to the system. The AMP can be configured to perform functions such as data acquisition, data analysis, data exchange, and the like, with local or remote assets, or with other task-specific processing devices. For example, the assets 110 may be an asset community (e.g., turbines, healthcare, power, industrial, manufacturing, mining, oil and gas, elevator, etc.) which may be communicatively coupled to the host platform 120.

In an example, external sensors can be used to sense information about a function of a machine or equipment, or to sense information about an environment condition at or near an asset, a worker, a downtime, a machine or equipment maintenance, and the like. The external sensor can be configured for data communication with the host platform 120 which can be configured to store the raw sensor information and transfer the raw sensor information over a network to a central location in the cloud platform where it can be accessed by the KPI spotlight analytic software described herein for further processing. Furthermore, operation of a manufacturing process at the manufacturing site 110 may be enhanced or otherwise controlled by a user inputting commands though an application hosted by the host platform 120 or other remote host platform such as a web server or system coupled to the host platform 120.

The host platform 120 may also host services that developers can use to build or test industrial or manufacturing-based applications and services to implement IIoT applications that interact with output data from the machine and equipment at the manufacturing site 110. For example, the host platform 120 may host a microservices marketplace where developers can publish their distinct services and/or retrieve services from third parties. In addition, the host platform 120 can host a multi-development framework for communicating with various available services or modules. A development framework can offer developers a variety of different frameworks which can be used by applications deployed on the host platform 120 to improve user experience in web or mobile applications. Developers can add and make accessible their applications (services, data, analytics, etc.) via the host platform 120.

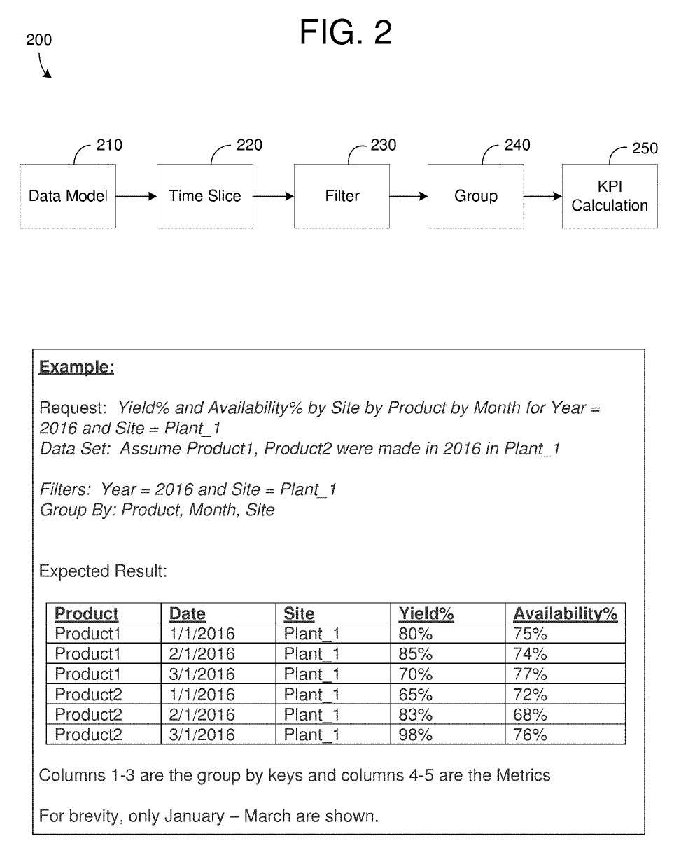

FIG. 2 illustrates a process 200 for determining a KPI in accordance with an example embodiment. FIG. 2 also illustrates a non-limiting example of determining a KPI metric. Referring to FIG. 2, process 200 applies a data model in 210, selects a window of time in 220, filters the window of time by one or more attributes in 230, groups the data according to one or more inputs in 240, and calculates the KPI in 250. The process 200 may be performed over different dimensions of the same data set or different data sets while extracting different portions of data from the data sets.

The data model in 210 may be based on a data set on which the KPI calculation is to be performed. The window of time 220 can be used to specify a portion of data from the data model that is to be processed. The filter 230 may include various conditions that are used to further limit the data model, such as time ranges, equipment/machines, products, operators, and the like. The selected data may be grouped in 240 based on input from the user. Examples of groups include by month, by week, by line, by product, by shift, and provides a way for arranging the selected data. Next, in 250 the KPI calculations is performed on the grouping of data to generate a metric. FIG. 2 further illustrates an example of determining a KPI for both yield and availability for a product which can be further limited by additional dynamic attributes of the manufacturing process such as date, site, product type, or the like.

The specific attributes from the time sliced data needed for calculating the KPI is dependent on the metrics being calculated. As a non-limiting example, for calculating a KPI for downtime actuals, the KPI process may use downtime duration and downtime categories. As another example, for calculating a KPE for work order actuals, the KPI process may use scrap counts, production counts, operation start/end times, work order start/end times, and the like. Other types of KPIs included, but are not limited to, cycle time, total change over time, mean change over time, change over time ratio (%), capacity utilization (%), planned vs emergency maintenance, availability, line stop, mean-time to repair (MTTR), mean-time between failure (MTBF), yield (%), throughput, and the like.

Other examples of KPIs that may be used to identify patterns of behavior within the manufacturing process include first time yield, rolled throughput yield, labor productivity, labor productivity analysis, plant uptime, production target, customer lead time, on time delivery, value added, value to weight ratio, days in inventory, product stock outs, unit costs, delivered costs, and the like. For example, first time through yield or FTT as it may sometimes be referred to as a measure of production efficiency, ability/skill, and quality. It measures how many goods are produced correctly without flaws or re-work as percentage of total units produced in a production process or value stream. This concept can also be easily applied to the service industry as a measure of service or orders delivered satisfactorily to customers the first time without any amendments, re-work, or complaints.

As another example, rolled throughput yield (RTY) is a similar measure to the first time through ratio or FTT, but it is interpreted as the probability that a unit of production or service will be produced/delivered correctly or of acceptable quality without it being scraped or rejected. For example, if a product is quoted as having a rolled throughput yield of 93%, it can be said that 93% of the time the product will be manufactured or service delivered without it being faulty or defective. The RTY calculation is slightly different than FTT. It needs two measures to be calculated before the final measure can be computed. These two measures are the defects per unit (DPU) and the defects per inspection (DPI).

As another example, labor productivity is a key performance indicator which shows how well each unit of labor is used to make a unit of output. It is commonly used in operations management and strategic analysis to compare the productivity of workers in different ways such as in the same or different industries and between manufacturing plants or work sites within an industry or a company.

However, simply providing a user with a KPI metric does not provide the user with context or insight into the cause of the KPI metric but simply tells the user a measure of a specific KPI quality. It is then typically up to the user to make sense of what is the cause of the KPI metric, how to adjust the KPI metric, if any additional underlying issues are present, and the like. In contrast, the example embodiments are configured to analyze the KPI metrics by performing analytics on top of the calculated KPI metrics to identify patterns or trends in operating behavior of a manufacturing process based on historical KPI data and contextual data of the manufacturing process (or similar manufacturing process). That is, the system can automatically detect patterns within a manufacturing process based on the KPI metrics thereby determining whether an instance of KPI metric (e.g., bad or good) is an isolated incident or whether the incident is part of a larger chain or pattern of instances. Furthermore, the system can identify context that could the cause (or is otherwise linked) to the pattern such as a product type, a day, a time of day, a time of year, an operator, a shift, and the like.

The number of interesting KPI metrics is virtually unlimited. That said, however, there are many typical industry metrics that most customers are interested in. The difference between a generic business intelligence system and the example embodiments, is that the system herein can determine the types of manufacturing metrics needed and have the projected analytic models in place to support quick and easy calculations. The system may uncover common patterns in the input data sets and calculation math, to allow a broader framework to be constructed. Some metrics are more applicable to different manufacturing styles and where possible this delineation may be made. Customers often have their own internal metrics that their businesses have standardized on. Some of these are process specific (e.g. rolling paper, filling bottles, drilling holes) and some are because that's the way it has always been done. Either way, success here lays in having a simple, scalable system that allow new metrics to be configured in by the end-user.

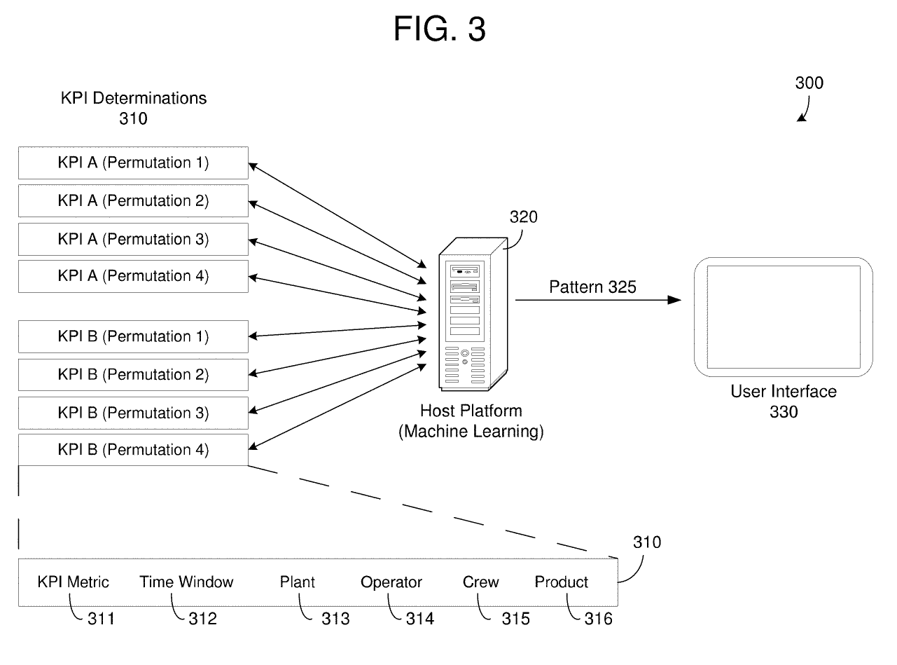

FIG. 3 illustrates a host platform 320 for detecting patterns from KPI metrics of a manufacturing process in accordance with an example embodiment. In this example, the host platform 320 constructs models of operating performance/behavior of a manufacturing process based on historical data of the manufacturing process or similar manufacturing processes. The models may identify a normal operating behavior (and KPIs) for a process. The KPIs may be uniquely selected for each manufacturing process by the host platform 320 or they may be selected by a user of the system. As another example, the models could be built elsewhere and provided to the host platform 320.

After the models have been generated or acquired by the host platform 320, the host platform 320 can detect patterns within a manufacturing process. In the example of FIG. 3, machine data is received and a plurality of KPIs 310 are calculated over different permutations of the data sets to determine a plurality of KPI metrics. For example, the host platform 320 may perform thousands, hundreds of thousands, or even millions of KPI calculations for different permutations of the data. Each permutation may be used to calculate a KPI metric 311 based on one or more dynamically changeable attributes such as a window of time 312 (e.g., hour, day, week, month, etc.), a plant location 313, a machine/an operator of the machine 314, a crew on shift 315, a product being manufactured 316, and the like. The host platform may calculate dozens of different KPIs across hundreds or even thousands of permutations for a given manufacturing process to determine KPI determinations 310. The host platform 320 may be a cloud platform having a clustered computing nodes capable of handling such a large data crunch.

Based on the KPI determinations 310, the host platform 320 may automatically detect one or more patterns of operational behavior within the manufacturing process and dynamically link the detected patterns to one or more attributes of the manufacturing process. For example, the host platform 320 may execute one or more analytic applications based on the KPI determinations 310 and historical data of the manufacturing process to identify the operational patterns. The operational patterns may include periods where a machine or equipment (or a process or person) is operating above or below a historical threshold. The host platform 320 may also determine a product that is included in the pattern. As another example, the host platform 320 may detect a recurring period of time at which the pattern is recurring (e.g., every day, every week, etc.). Furthermore, the host platform 320 may detect one or more users that are associated with the operational pattern such as an operator, a crew/shift of workers, and the like.

As a non-limiting example, a peak production analytic may be used to identify a peak demand for producing a product, group of products, or the like and also provide insight into how the manufacturing site performed during this period versus the times of average behavior. Here, the first step is to calculate the production counts during a time (T1-T2) aggregated into a time interval TG

T₁—Time Period Start

T₂—Time Period End

T_{G}—Time Interval

For example, values for T1 and T2 may be the last 1-2 years and a value for time interval may be weekly.

In this example,

ProductionCount(ProductGroup,Interval)=ΣProuductionCount(ProductGroup,Tg)

This returns a vector of data. Assuming 1 year and weekly, 52 values would be returned for each Product Group.

The next step is to statistically identify the time windows at which production is significantly different, these are the Peak Production Time Windows (PPTW). The next step is to compare the behavior of metrics during these PPTW vs the behavior for non PPTW and show the differences. This information will allow customers/users to determine how to better operate during PPTW. For example, the information might provide insight into expected outcomes and mitigations, lower PPTW availability, plan more scheduled maintenance before/at the start of PPTW periods, and the like.

After detecting the patterns and the context linked to the patterns, the host platform 320 may output information about the detected pattern and the context for display to a user interface 330. Here, the user interface 330 may be included in an embedded display of the host platform 320 or it may be another device or group of devices which are connected to the host platform 320 via a network, a cable, etc.

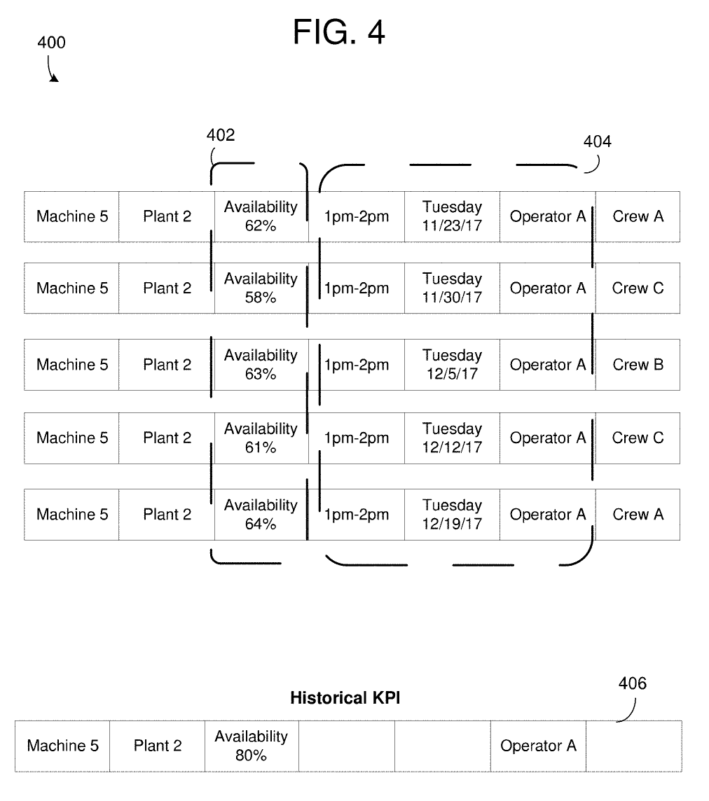

FIG. 4 illustrates an example of a user interface 400 displaying operating patterns of a manufacturing process in accordance with an example embodiment. In this example, the host platform (e.g., host platform 120, host platform 320, or the like) detects that availability of a machine (i.e., machine 5) within a manufacturing plant (i.e., plant 2) lacks availability in comparison to its historical average 406. In particular, the host platform determines that availability of machine 5 is down on Tuesdays between 1 pm-2 pm when Operator A is operating machine 5. To notify an engineer/operator managing the plant, the system may output KPI information and context via the user interface 400 which includes an identification of the KPI metrics 402 used to determine the pattern and common contextual attributes 404 which include an operator, a time of day, and a day of the week. Here, the contextual attributes may be dynamic across the manufacturing process but common to the KPI determinations included in the detected pattern. Furthermore, the host platform may also output a display of the historical average of the KPI 406 for the machine to provide additional insight into the manager/engineer.

Upon learning of the reduction in availability, the operating engineer may send a message to Operator A or place a call to Operator A and discover that Operator A has a violin lesson on Tuesdays between 12 pm-1 pm, and as a result, is a few minutes late back from break/lunch.

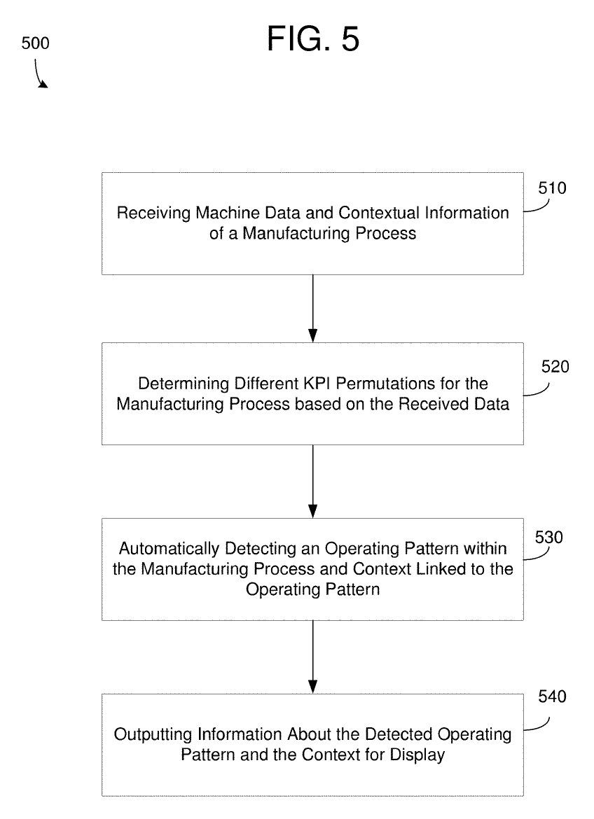

FIG. 5 illustrates a method 500 for detecting patterns from a manufacturing process in accordance with another example embodiment. For example, the method 500 may be performed by one or more computing system including a web server, a cloud platform, an industrial server, an edge server, a computing device (e.g., desktop, mobile device, appliance, etc.), a database, an on-premises server, and the like. Referring to FIG. 5, in 510 the method includes receiving machine data from a manufacturing process and receiving contextual information associated with the manufacturing process. For example, the contextual information may include a plurality of dynamic contextual attributes that change over time such as an operator, a product being manufactured, a machine, a plant, a time frame, a crew on shift, and the like. The contextual information may be included in a text file, a spreadsheet, or some other computer readable file or data. The manufacturing process may include an industrial manufacturing process which includes machine operations for manufacturing a product. Non-limiting examples of manufacturing processes include milling operations such as rolling paper, machining goods such as clothing, wood, tile, rubber, etc., drilling operations for fuel sources, assembly line manufacturing, and the like. The type of manufacturing process and the machines/equipment used are not limited within the example embodiments.

In 520, the method includes determining KPIs for different permutations of the manufacturing process, where each KPI permutation is associated with a plurality of values for the plurality of dynamic contextual attributes, respectively. For example, the KPIs may be measured for each cycle (e.g., every hour, every day, every week, etc.) of a product being manufactured, an operator shift, a crew shift, and the like. The KPIs may be calculated in real-time or they may be calculated after the data has been accumulated for a period of time such as a day, a week, a month, etc. The KPIs may be used to measure operational efficiency of one or more of a machine and an equipment used during the manufacturing process. As a non-limiting example, the KPIs may measure one or more of cycle time, change over time, capacity utilization, availability, line stop, yield and throughput, associated with the manufacturing process.

In 530, the method includes automatically detecting an operating pattern within the manufacturing process based on the determined KPIs and automatically detecting one or more values of the plurality of dynamic contextual attributes linked to the detected operating pattern. For example, the automatically detecting may include identifying a part of the manufacturing process performing above or below a predefined threshold, a range of time the manufacturing process is performing above or below the predefined threshold, and at least one user associated with the identified part of the manufacturing process at the identified range of time. In this example, the detecting the operating pattern may be performed by identifying an operating pattern within the determined KPI permutations based on historical KPI information of the manufacturing process. The historical KPI information may be used by the system to develop models of behavior using machine learning algorithms.

In 540, the method includes outputting information about the detected operating pattern and the one or more values of the plurality of dynamic contextual attributes linked to the detected operating pattern for display on a display device. For example, the outputting may include displaying information about one or more KPIs used to identify the detected operating pattern via a user interface (dashboard) and hiding or otherwise removing information about other KPIs that are not used to identify the detected operating pattern from being displayed on the user interface.

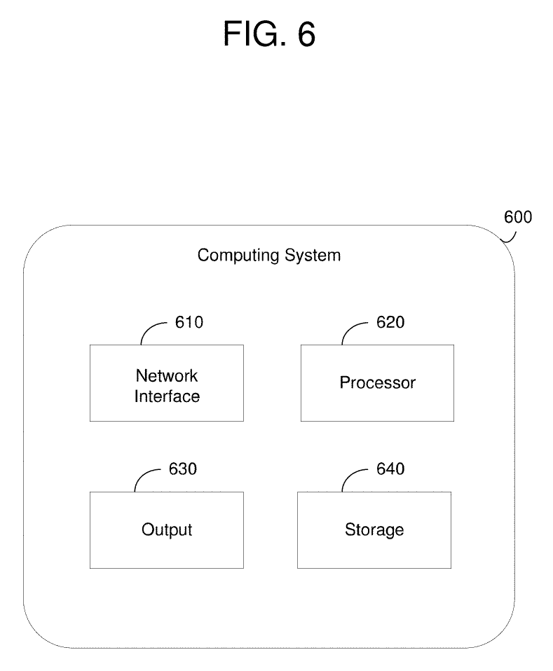

FIG. 6 illustrates a computing system 600 in accordance with an example embodiment. For example, the computing system 600 may be a database, an instance of a cloud platform, a streaming platform, and the like. In some embodiments, the computing system 600 may be distributed across multiple devices. Also, the computing system 600 may perform the method 500 of FIG. 5. Referring to FIG. 6, the computing system 600 includes a network interface 610, a processor 620, an output 630, and a storage device 640 such as a memory. Although not shown in FIG. 6, the computing system 600 may include other components such as a display, one or more input units, a receiver, a transmitter, and the like.

The network interface 610 may transmit and receive data over a network such as the Internet, a private network, a public network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The output 630 may output data to an embedded display of the computing system 600, an externally connected display, a display connected to the cloud, another device, and the like. The output 630 may include a device such as a port, an interface, or the like, which is controlled by the processor 620. In some examples, the output 630 may be replaced by the processor 620. The storage device 640 is not limited to a particular storage device and may include any known memory device such as RAM, ROM, hard disk, and the like, and may or may not be included within the cloud environment. The storage device 640 may store software modules or other instructions which can be executed by the processor 620.

According to various embodiments, the network interface 610 may receive machine data from a manufacturing process and contextual information associated with the manufacturing process. For example, the manufacturing data and the contextual data may be received from a database, from an industrial PC, an edge server, an on-premises server, and the like, which stores the machine data when it is received from the machines. As another example, the network interface 610 may receive the machine data directly from the machines. The contextual information may include a plurality of dynamic contextual attributes that change over time such as a product being manufactured, an operator, a machine used, a time frame, a crew, and the like.

The processor 620 may determine KPIs for different permutations of the manufacturing process, where each KPI permutation is associated with a plurality of values for the plurality of dynamic contextual attributes, respectively. Furthermore, the processor 620 may automatically detect an operating pattern within the manufacturing process based on the determined KPIs and automatically detect one or more values of the plurality of dynamic contextual attributes linked to the detected operating pattern. The operating pattern may include a pattern of operation for a part of the manufacturing process that is operating above or below a predetermined threshold. The operating pattern may also be linked to one or more of a user, a recurring period of time (e.g., once a day, once a week, etc.), a crew/shift, a product type, or the like. The output 630 may output information about the detected operating pattern and the one or more values of the plurality of dynamic contextual attributes linked to the detected operating pattern for display on a display device. For example, the output 630 may display information about one or more KPIs used to identify the detected operating pattern via a user interface and hide or otherwise remove information about other KPIs that are not used to identify the detected operating pattern.

In some embodiments, the processor 620 may automatically identify a part of the manufacturing process (e.g., one or more machines and/or equipment) performing above or below a predefined threshold, a range of time the manufacturing process is performing above or below the predefined threshold, and at least one user associated with the identified part of the manufacturing process at the identified range of time. For example, the processor 620 may automatically identify an operating pattern within the determined KPI permutations based on historical KPI information of the manufacturing process. The historical KPI information may be used by the processor 620 to generate models of operating patterns based on historical KPI information which may be generated by the processor 620 executing one or more machine learning algorithms on the historical data and stored in the storage 640.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), a random-access memory (RAM) and/or any non-transitory transmitting/receiving medium such as the Internet, cloud storage, the Internet of Things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a network interface configured to receive machine data from a manufacturing process and contextual information associated with the manufacturing process, the contextual information including a plurality of dynamic contextual attributes that change over time;
a processor configured to determine key performance indicators (KPIs) for different permutations of the manufacturing process, where each KPI permutation is associated with a plurality of values for the plurality of dynamic contextual attributes, respectively, and automatically detect an operating pattern within the manufacturing process based on the determined KPIs and automatically detect one or more values of the plurality of dynamic contextual attributes linked to the detected operating pattern; and
an output configured to output information about the detected operating pattern and the one or more values of the plurality of dynamic contextual attributes linked to the detected operating pattern for display on a display device.

2. The computing system of claim 1, wherein the dynamic contextual attributes comprise attributes that dynamically change during the manufacturing process and include one or more of a window of time, an operator of a machine, a product being manufactured, and a manufacturing crew on shift.

3. The computing system of claim 2, wherein the dynamic contextual attributes comprise a selected window of time, and further comprise one or more of an operator of a machine during the window of time, a product being manufactured during the window of time, and a crew on shift during the window of time.

4. The computing system of claim 1, wherein the processor is configured to automatically identify a part of the manufacturing process performing above a predefined threshold, a range of time the manufacturing process is performing above the predefined threshold, and at least one user associated with the identified part of the manufacturing process at the identified range of time.

5. The computing system of claim 1, wherein the processor is configured to automatically identify a part of the manufacturing process performing below a predefined threshold, a range of time the manufacturing process is performing below the predefined threshold, and at least one user associated with the identified part of the manufacturing process at the identified range of time.

6. The computing system of claim 1, wherein the determined KPIs measure one or more of cycle time, change over time, capacity utilization, availability, line stop, yield and throughput, associated with the manufacturing process.

7. The computing system of claim 1, wherein the processor is configured to automatically identify an operating pattern within the determined KPI permutations based on historical KPI information of the manufacturing process.

8. The computing system of claim 1, wherein the output is configured to display information about one or more KPIs used to identify the detected operating pattern and hide information about other KPIs that are not used to identify the detected operating pattern.

9. The computing system of claim 1, wherein the manufacturing process comprises an industrial manufacturing process which includes machine operations for manufacturing a product.

10. A computer-implemented method comprising:
receiving machine data from a manufacturing process and contextual information associated with the manufacturing process, the contextual information including a plurality of dynamic contextual attributes that change over time;
determining key performance indicators (KPIs) for different permutations of the manufacturing process, where each KPI permutation is associated with a plurality of values for the plurality of dynamic contextual attributes, respectively;
automatically detecting an operating pattern within the manufacturing process based on the determined KPIs and automatically detecting one or more values of the plurality of dynamic contextual attributes linked to the detected operating pattern; and
outputting information about the detected operating pattern and the one or more values of the plurality of dynamic contextual attributes linked to the detected operating pattern for display on a display device.

11. The computer-implemented method of claim 10, wherein the dynamic contextual attributes comprise attributes that dynamically change during the manufacturing process and include one or more of a window of time, an operator of a machine, a product being manufactured, and a manufacturing crew on shift.

12. The computer-implemented method of claim 11, wherein the dynamic contextual attributes comprise a selected window of time, and further comprise one or more of an operator of a machine during the window of time, a product being manufactured during the window of time, and a crew on shift during the window of time.

13. The computer-implemented method of claim 10, wherein the automatically detecting comprises identifying a part of the manufacturing process performing above a predefined threshold, a range of time the manufacturing process is performing above the predefined threshold, and at least one user associated with the identified part of the manufacturing process at the identified range of time.

14. The computer-implemented method of claim 10, wherein the automatically detecting comprises identifying a part of the manufacturing process performing below a predefined threshold, a range of time the manufacturing process is performing below the predefined threshold, and at least one user associated with the identified part of the manufacturing process at the identified range of time.

15. The computer-implemented method of claim 9, wherein the determined KPIs measure one or more of cycle time, change over time, capacity utilization, availability, line stop, yield and throughput, associated with the manufacturing process.

16. The computer-implemented method of claim 10, wherein the automatically detecting the operating pattern comprises identifying an operating pattern within the determined KPI permutations based on historical KPI information of the manufacturing process.

17. The computer-implemented method of claim 10, wherein the outputting comprises displaying information about one or more KPIs used to identify the detected operating pattern and hiding information about other KPIs that are not used to identify the detected operating pattern.

18. The computer-implemented method of claim 10, wherein the manufacturing process comprises an industrial manufacturing process which includes machine operations for manufacturing a product.

19. A non-transitory computer readable medium comprising program instructions which when executed cause a processor to perform a method comprising:
receiving machine data from a manufacturing process and contextual information associated with the manufacturing process, the contextual information including a plurality of dynamic contextual attributes that change over time;
determining key performance indicators (KPIs) for different permutations of the manufacturing process, where each KPI permutation is associated with a plurality of values for the plurality of dynamic contextual attributes, respectively;
automatically detecting an operating pattern within the manufacturing process based on the determined KPIs and automatically detecting one or more values of the plurality of dynamic contextual attributes linked to the detected operating pattern; and
outputting information about the detected operating pattern and the one or more values of the plurality of dynamic contextual attributes linked to the detected operating pattern for display on a display device.

20. The non-transitory computer readable medium of claim 19, wherein the dynamic contextual attributes comprise attributes that dynamically change during the manufacturing process and include one or more of a window of time, an operator of a machine, a product being manufactured, and a manufacturing crew on shift.
